(19) United States
(12) Patent Application Publication
(10) Pub. No.: US 2010/0109460 A1
(43) Pub. Date: May 6, 2010

(54) Motor

(76) Inventor: Alex Horng, Kaohsiung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/343,605

(22) Filed: Dec. 24, 2008

(30) Foreign Application Priority Data
Nov. 4, 2008 (TW) 097142584

(51) Int. Cl. H02K 15/14

(52) U.S. Cl. 310/90

(57) ABSTRACT

A motor includes a base, a stator, a retaining seat, a bearing, a retaining ring and a rotor. The base has a shaft tube with an assembling hole. The stator is mounted around the shaft tube. The retaining seat, bearing and retaining ring are received in the assembling hole. Outer diameters of the retaining seat and the retaining ring are equal to a diameter of the assembling hole. The bearing is sandwiched and positioned between the retaining ring and the retaining seat. Radial and axial movement of the retaining seat, the bearing and the retaining ring is avoided effectively after being mounted into the shaft tube, so that the rotor is smoothly coupled to the retaining ring, the nearing and the retaining seat. Consequently, convenience of assembling and a simplified structure are provided.

### BACKGROUND OF THE INVENTION

1. Field of the Invention

The present invention relates to a motor and, more particularly, to a motor that has a dual retaining function and provides convenience of assembling.

2. Description of the Related Art

A conventional motor is described in Taiwan Patent Publication No. 200811372 (with Issue No. I304115) entitled “FAN”. Referring to FIG. 1, the fan includes a motor 90 having a base 91 preferably forming a casing of the fan, a sliding bearing 92, a stator 93, an oil end cap 94, a rotor 95 with a shaft 951, an upper retaining ring 96 with a first through hole 961, and a lower retaining ring 97 with a second through hole 971. The base 91 has a shaft tube 911 with a top and a bottom thereof open. A portion of the shaft tube 911 close to the top thereof is bent downwards and inwards to form an annular abutting flange 912 and an inner surface of the shaft tube 911 adjacent to the bottom thereof forms a thread 913. The sliding bearing 92 is received in the shaft tube 911 and has a center hole 921. The stator 93 is mounted around the shaft tube 911 and the oil end cap 94 is coupled inside the shaft tube 911 and engages with the thread 913. The upper retaining ring 96 and the lower retaining ring 97 are mounted around the shaft 951 and close to two ends of the shaft 951 respectively. By this arrangement, the stator 93 is able to drive the rotor 95 to revolve around the stator 93. And the upper retaining ring 96 and the lower retaining ring 97 jointly constitute a double retaining feature of the motor 90 to prevent the rotor 95 from disengaging from the base 91 during rotation.

Referring to FIG. 2, in assembly of the conventional motor 90, the upper retaining ring 96, the sliding bearing 92, the lower retaining ring 97 and the oil end cap 94 are disposed into the shaft tube 911 in sequence through the bottom opening of the shaft tube 911, with the oil end cap 94 engaging with the thread 913. And then the shaft 951 of the rotor 95 sequentially passes through the top opening of the shaft tube 911, the first through hole 961, the center hole 921 and the second through hole 971. Consequently, the shaft 951 can smoothly revolve in the sliding bearing 92. Nevertheless, said conventional motor 90 has several drawbacks in assembly as the following.

First, as seen in FIG. 3, the upper retaining ring 96 is sandwiched between the annular abutting flange 912 and the sliding bearing 92 when the upper retaining ring 96 and the sliding bearing 92 are received in the shaft tube 911, but this arrangement does not provide the upper retaining ring 96 with a reliable radial positioning effect. Because the upper retaining ring 96 is liable to move radially after being received in the shaft tube 911, a gap “D” is formed between a central line of the first through hole 961 of the upper retaining ring 96 and a central line of the center hole 921 of the sliding bearing 92. Thus, the gap “D” will lead to difficulty of passing the shaft 951 through the first through hole 961 and the center hole 921 in sequence. And therefore, the arrangement of the upper retaining ring 96 may need to be adjusted again for complete insertion of the shaft 951 into the shaft tube 911. As a result, inconvenience of assembling the motor 90 is caused.

Second, the lower retaining ring 97 is disposed on a top of the oil end cap 94 in assembly of the motor 90 and then the oil end cap 94 is fixed to the bottom of the shaft tube 911 by engaging with the thread 913. If the oil end cap 94 is not completely screwed into a predetermined position inside the shaft tube 911, the lower retaining ring 97 will not be stably sandwiched between the sliding bearing 92 and the oil end cap 94, and thus axial movement of the lower retaining ring 97 occurs. And that results in difficulty of passing the shaft 951 of the rotor 95 through the second through hole 971. As shown in FIG. 4, even if the shaft 951 successfully passes through the second through hole 971, an inner edge of the lower retaining ring 97 still will not extend into a annular groove 952 of the shaft 951 because the lower retaining ring 97 is not at a right position for assembling the motor 90. Therefore, due to the way, screwing, by which the oil end cap 94 engages with the shaft tube 911, a reliable radial positioning effect on the lower retaining ring 97 is probably inaccessible, and thus the lower retaining ring 97 can be at a wrong position for assembling the motor 90. Hence, there is a high probability of an occurrence of incomplete combination of the rotor 95 and the stator 93. Consequently, extra manpower and time to adjust the positions of the lower retaining ring 97 and the oil end cap 94 relative to the shaft tube 911 are necessary for assurance of a fine assembly of the motor 90.

Third, there are too many components, such as the sliding bearing 92, the oil end cap 94, the upper retaining ring 96 and the lower retaining ring 97, received in the shaft tube 911, and these components results in a complex structure and complex steps for assembling. Besides, additional processing procedures are needed for forming the annular abutting flange 912 and the thread 913. Thus, inconvenience of assembling the motor 90 is caused and production cost of the motor 90 is increased.

In conclusion, although departure of the rotor 95 from the base 91 is avoided by the upper retaining ring 96 and the lower retaining ring 97 jointly constituting the double retaining feature, problems of inconvenience of assembling and the complex structure for assembly result in extra manpower and time for adjustment of assembly of the conventional motor 90. Hence, there is a need for an improvement over the conventional motor.

### SUMMARY OF THE INVENTION

It is therefore the primary objective of this invention to provide a motor that overcomes the problems of the prior art described above to allow convenience of assembling and a simplified structure.

A motor according to the preferred teachings of the present invention includes a base, a stator, a retaining seat, a bearing, a retaining ring and a rotor. The base has a shaft tube with an assembling hole. Two ends of the shaft tube are an open end and a closed end respectively. The stator is mounted around the shaft tube. The retaining seat includes a first axial hole and is received in the assembling hole. The retaining seat is disposed at the closed end of the shaft tube and an outer diameter of the retaining seat is equal to a diameter of the assembling hole. The bearing has a center hole and is received in the assembling hole of the shaft tube. The bearing abuts the retaining seat. The retaining ring has a second axial hole and is received in the assembling hole of the shaft tube. An outer diameter of the retaining ring is equal to the diameter of the assembling hole. The bearing is sandwiched and positioned between the retaining ring and the retaining seat. The rotor includes a shaft having a first annular groove in a neck shape and a second annular groove in a neck shape formed in an outer periphery thereof to respectively form a first neck and a second neck of the shaft. An outer diameter of the first neck is smaller than a diameter of the first axial hole of the retaining seat and an outer diameter of the second neck is smaller than a diameter of the second axial hole of the retaining ring. The shaft passes through the second axial hole, the center hole and the first axial hole, with the retaining seat and the retaining ring surrounding and partially extending into the first annular groove and the second annular groove respectively. Accordingly, radial and axial movement of the retaining seat, the bearing and the retaining ring is avoided effectively after being mounted into the shaft tube to provide convenience of assembling and a simplified structure.

In an example, the assembling hole has an upper hole adjacent to the open end and a lower hole in communication with the upper hole and adjacent to the closed end, with a diameter of the upper hole being larger than a diameter of the lower hole to form a shoulder in an inner periphery of the assembling hole and between the upper hole and the lower hole, with the outer diameter of the retaining seat being equal to a diameter of the lower hole and the outer diameter of the retaining ring being equal to a diameter of the upper hole, with the retaining ring abutting against the shoulder. Accordingly, there is no axial movement of the retaining ring to reliably position the retaining ring.

In an example, the stator includes an abutting member on a top thereof, with the abutting member abutting against and positioning the retaining ring. Accordingly, the retaining seat, the bearing and the retaining ring disengaging from the shaft tube of the base is effectively avoided.

In an example, the abutting member is in the form of a plurality of pressing plates, with each pressing plate having one end fixed to the stator and another end extending into the assembling hole of the shaft tube of the base, with the ends of the pressing plates which extend into the assembling hole abutting against the retaining ring. Accordingly, the pressing plates can abut against the top of the retaining ring to provide more reliably positioning effect on the retaining ring.

In an example, the motor further includes a positioning ring coupled in the shaft tube of the base and abutting the retaining ring, with the retaining ring being sandwiched between the positioning ring and the bearing. Accordingly, the retaining seat, the bearing and the retaining ring disengaging from the shaft tube of the base is effectively avoided.

In an example, the positioning ring has an L-shape cross-section from an axial center line of the positioning ring to a radial outer edge thereof. Accordingly, a contact area between the inner periphery of the shaft tube and the positioning ring is increased to improve coupling stability of a combination of the positioning ring and the shaft tube.

In an example, the diameter of the second axial hole of the retaining ring is larger than the diameter of the first axial hole of the retaining seat. Accordingly, convenience of assembling is further enhanced, under retaining effect of the retaining seat and the retaining ring.

In an example, the shaft tube includes an annular protrusion on an outer periphery thereof, with a bottom of the stator abutting on the annular protrusion. Accordingly, the stator is supported by the annular protrusion to enhance convenience of assembling the motor.

Further scope of the applicability of the present invention will become apparent from the detailed description given hereinafter. However, it should be understood that the detailed description and specific examples, while indicating preferable embodiments of the invention, are given by way of illustration only, since various will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a cross sectional view illustrating a conventional motor;

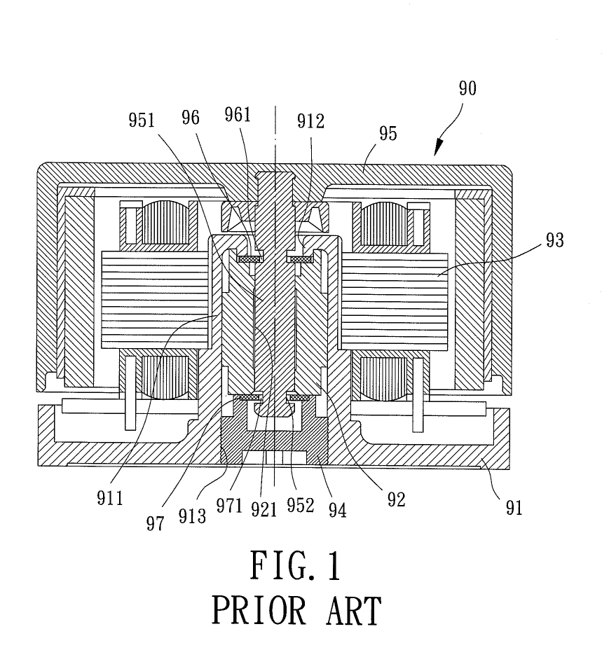

FIG. 2 is a cross sectional view illustrating the conventional motor in assembly;

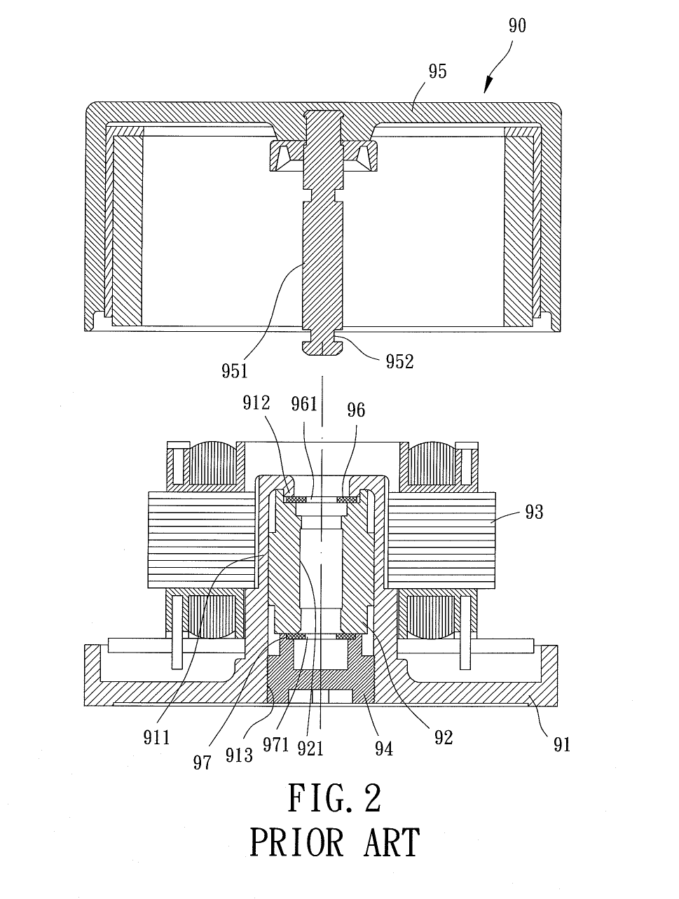

FIG. 3 is an enlarged detailed cross sectional view illustrating misalignment of central lines of a retaining ring and a bearing of the conventional motor;

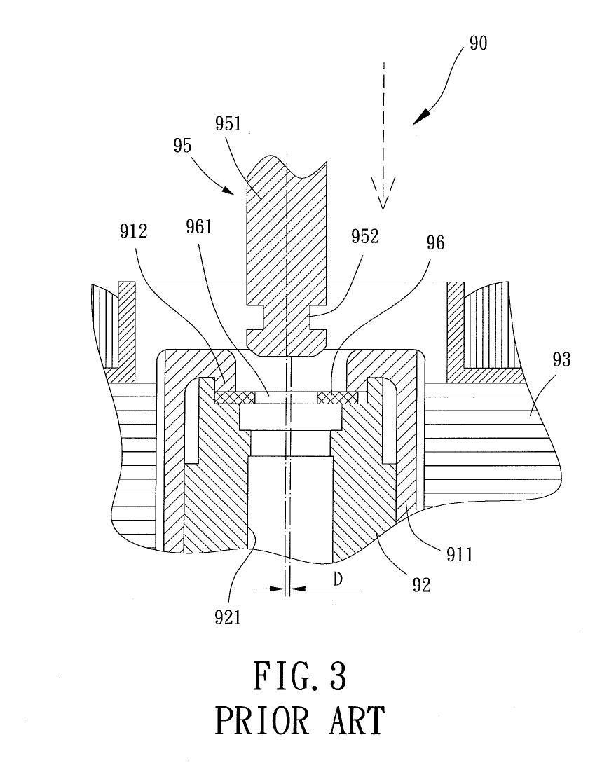

FIG. 4 is a cross sectional view illustrating assembly failure of the conventional motor;

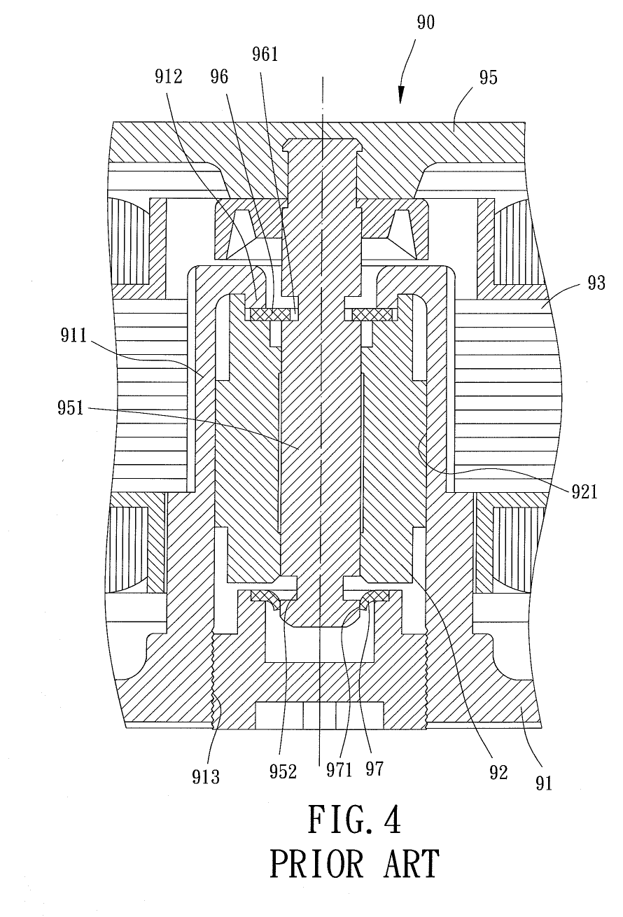

FIG. 5 is an exploded perspective view illustrating a motor in accordance with a first embodiment of the present invention;

FIG. 6 is a cross sectional view illustrating the motor in accordance with the first embodiment of the present invention;

FIG. 7 is a cross sectional view illustrating the motor in accordance with the first embodiment of the present invention in assembly;

FIG. 8 is an exploded perspective view illustrating a motor in accordance with a second embodiment of the present invention;

FIG. 9 is a cross sectional view illustrating the motor in accordance with the second embodiment of the present invention; and

FIG. 10 is a cross sectional view illustrating the motor in accordance with the second embodiment of the present invention in assembly.

In the various figures of the drawings, the same numerals designate the same or similar parts. Furthermore, when the terms “first”, “second”, “annular”, “axial”, “radial”, “outer”, “inner”, “section”, “portion”, “end”, “lower”, “upper”, “inwards”, “longitudinal” and similar terms are used hereinafter, it should be understood that these terms are reference only to the structure shown in the drawings as it would appear to a person viewing the drawings and are utilized only to facilitate describing the invention.

### DETAILED DESCRIPTION OF THE INVENTION

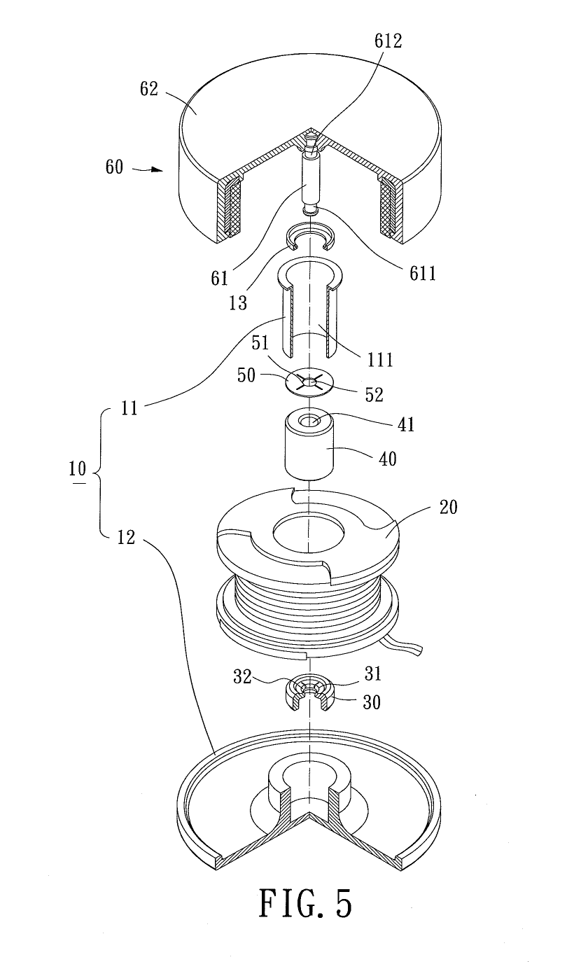

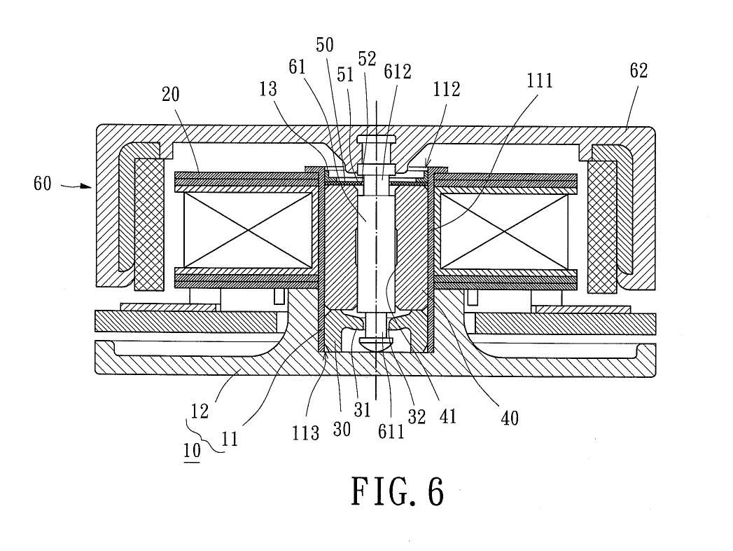

A motor of a first embodiment according to the preferred teachings of the present invention is shown in FIGS. 5 and 6 of the drawings. According to the first embodiment form shown, the motor includes a base 10, a stator 20, a retaining seat 30, a bearing 40, a retaining ring 50 and a rotor 60. Optionally, the base 10 can be designed as a frame of a fan, such that the motor of the present invention can be utilized for a heat-dissipating fan. Furthermore, the stator 20 and the bearing 40 is mounted to the base 10 and the rotor 60 rotatably couples to the bearing 40, so that the stator 20 is able to drive the rotor 60 to rotate. The rotor 60 may couple to a plurality of blades (not illustrated) on an outer periphery thereof to be jointly regarded as an impeller when the motor of the present invention is used as the heat-dissipating fan. The retaining seat 30 and the retaining ring 50 are mounted to the rotor 60 for the rotor 60 to avoid disengaging from the base 10 during packing, conveyance or utilization of the motor, wherein the retaining ring 50 can be taken as an oil leak-proof member. Therefore, the retaining seat 30 and the retaining ring 50 jointly constitute a double retaining feature of the motor according to the preferred teachings of the present invention, such that the motor has a dual retaining function to enhance convenience of assembling, provide a simplified structure and avoid oil leakage.

The base 10 of the first embodiment according to the preferred teachings of the present invention has a shaft tube 11 made of metal and a plate 12 for the shaft tube 11 to securely mount, wherein the shaft tube 11 and plate 12 are two separate pieces. The shaft tube 11 has an assembling hole 111 and two ends of the shaft tube 11 are an open end 112 away from the plate 12 and a closed end 113 formed by the shaft tube 11 and the plate 12 jointly, as shown in FIG. 6. Or the shaft tube 11 can form the closed end 113 alone.

The stator 20 of the first embodiment according to the preferred teachings of the present invention is mounted around the shaft tube 11 of the base 10.

The retaining seat 30 of the first embodiment according to the preferred teachings of the present invention is a hollow cylindrical member having a longitudinal through-hole. An inner periphery of the retaining seat 30 radially extends a plurality of first retaining plates 31 toward a central line of the longitudinal through-hole to define a first axial hole 32, with the first retaining plates 31 close to one end of the retaining seat 30. Furthermore, the retaining seat 30 is received in the assembling hole 111 and disposed at the closed end 113 of the shaft tube 11, with an outer diameter of the retaining seat 30 being equal to a diameter of the assembling hole 111 of the shaft tube 11. Hence, the retaining seat 30 radially abuts on an inner surface defining the assembling hole 111 and thus is positioned inside the shaft tube 11 without radial movement.

The bearing 40 of the first embodiment according to the preferred teachings of the present invention has a center hole 41 and is also received in the assembling hole 111 of the shaft tube 11. A bottom end face of the bearing 40 abuts against a top end face of the retaining seat 30 close to the first retaining plates 31, with the center hole 41 of the bearing 40 being aligned with the first axial hole 32 of the retaining seat 30. Besides, an outer diameter of the bearing 40 is preferable equal to the diameter of the assembling hole 111 of the shaft tube 11, so that the bearing 40 also radially abuts on the inner surface defining the assembling hole 111 and is positioned inside the shaft tube 11 without radial movement.

An inner periphery of the retaining ring 50 of the first embodiment plurality of second retaining plates 51 toward a central line of the retaining ring 50 to define a second axial hole 52. The retaining ring 50 is received in the assembling hole 111 of the shaft tube 11, and a bottom end face of the retaining ring 50 abuts against a top end face of the bearing 40, with an outer diameter of the retaining ring 50 being equal to the diameter of the assembling hole 111 of the shaft tube 11. Therefore, the retaining ring 50 radially abuts on the inner surface defining the assembling hole 111 and is positioned inside the shaft tube 11 without radial movement, with the second axial hole 52 being aligned with the center hole 41 of the bearing 40. In addition, the bearing 40 is positioned and sandwiched between the retaining seat 30 and the retaining ring 50.

The rotor 60 of the first embodiment according to the preferred teachings of the present invention has a shaft 61 and a cap 62, with one end of the shaft 61 securely coupling to the cap 62 and the other end of the shaft 61 as a free end rotatably extending into the shaft tube 11. A first annular groove 611 and a second annular groove 612 are both formed on an outer periphery of the shaft 61, with the first and second annular grooves 611, 612 being respectively close to two ends of the shaft 61 to form a first neck and a second neck of the shaft 61. In addition, each of the first and second necks of the shaft 61 has an outer diameter smaller than that of two sections of the shaft 61, with said two sections being adjacent to two end edges of each of the first and second annular grooves 611, 612. A diameter of the first axial hole 32 of the retaining seat 30 is smaller than the outer diameters of the two sections adjacent to the first neck of the shaft 61 but larger than the outer diameter of the first neck of the shaft 61. Similarly, a diameter of the second axial hole 52 of the retaining ring 50 is smaller than the outer diameters of the two sections adjacent to the second neck of the shaft 61 but larger than the outer diameter of the second neck of the shaft 61. Besides, after the shaft 61 is forcibly inserted into the assembling hole 111 and passes through the second axial hole 52, the center hole 41 and the first axial hole 32, each first retaining plate 31 of the retaining seat 30 extends into the first annular groove 611 while each second retaining plate 51 of the retaining ring 50 extends into the second annular groove 612, with free ends of the first retaining plates 31 which define the first axial hole 32 being in the first annular groove 611 and free ends of the second retaining plates 51 which define the second axial hole 52 being in the second annular groove 612. Therefore, the dual retaining function jointly provided by the retaining seat 30 and the retaining ring 50 can avoid disengagement of the rotor 60 from the base 10 during packing, conveyance or utilization of the motor.

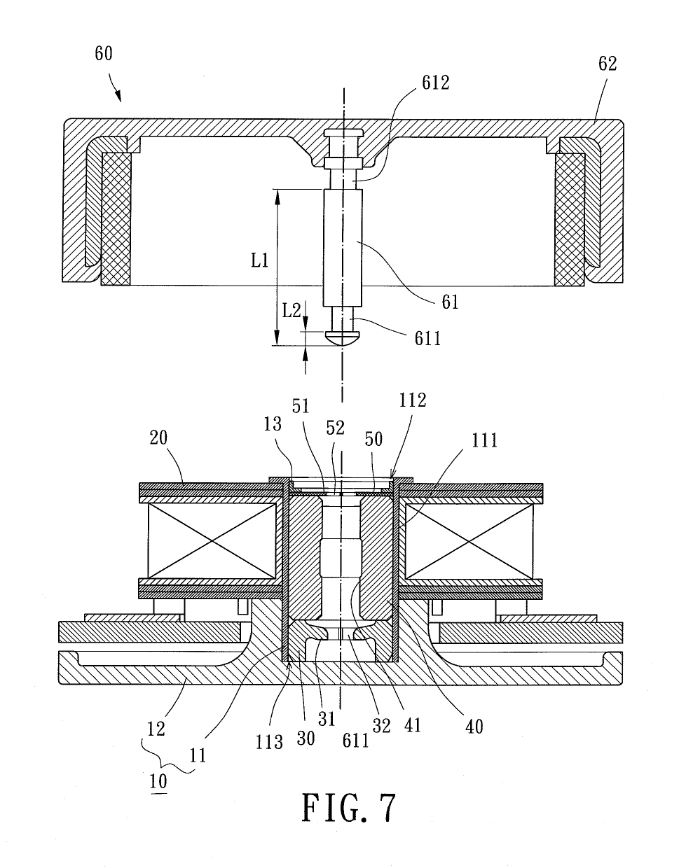

Further, referring to FIG. 7, the diameter of the second axial hole 52 of the retaining ring 50 is preferable larger than that of the first axial hole 32 of the retaining seat 30. In assembly, the retaining seat 30, the bearing 40 and the retaining ring 50 are mounted into the shaft tube 11 of the base 10, and then the shaft 61 of the rotor 60 goes through the retaining ring 50, the bearing 40 and the retaining seat 30. Besides, a first portion of the shaft 61 between the second annular groove 612 and the free end of the shaft 61 has a first longitudinal distance “L1”, and a second portion of the shaft 61 between the first annular groove 611 and the free end of the shaft 61 has a second longitudinal distance “L2”. And it is obvious that the first axial hole 32 of the retaining seat 30 is for the second portion to forcibly go through and the second axial hole 52 of the retaining ring 50 is for the first portion to forcibly go through when the shaft 61 is projecting into the assembling hole 111. Therefore, with the first longitudinal distance “L1” being much longer than the second longitudinal distance “L2” and the first axial hole 32 being merely for the second portion to pass through, it will be much easy for the rotor 60 to couple with the shaft tube 11 by designing the diameter of the second axial hole 52 being larger than that of the first axial hole 32. Thus, in addition to offering a reliable retaining effect, the retaining seat 30 and the retaining ring 50 with said difference between the first and second axial holes 32, 52 can also decrease a difficulty for assembling of the rotor 60 and the shaft tube 11. That is, by this configuration described above, the motor of the present invention can further provide convenience of assembling with allowing the retaining effect on the shaft 61.

Moreover, the retaining ring 50 fixed inside the shaft tube 11 provides blocking effect to avoid disengagement of the retaining seat 30 and the bearing 40 relative to the shaft tube 11, as well as leakproof effect to prevent oil inside the shaft tube 11 from leaking. The retaining ring 50 is fixed in the shaft tube 11 and coupled to the top of the bearing 40 with close-fit, adhesive or other methods, and it is preferable to achieve said coupling by a positioning ring 13 (seen in FIG. 6). The positioning ring 13 is fixed in the shaft tube 11 of the base 10, with the positioning ring 13 abutting against the retaining ring 50, so that the retaining ring 50 is sandwiched and retained between the positioning ring 13 and the bearing 40. And the positioning ring 13 preferably has an L-shape cross-section from a axial center line of the positioning ring 13 to a radial outer edge thereof, with a lateral wall of the positioning ring 13 contacting with the inner surface of the shaft tube 11 defining the assembling hole 111, to increase a contact area between the inner surface and the positioning ring 13, so that a combination of the positioning ring 13 and the shaft tube 11 with enhanced reliability and stability is provided. Therefore, the retaining seat 30, the bearing 40 and the retaining ring 50 disengaging from the shaft tube 11 is prevented effectively.

Referring to FIGS. 5 to 7, the motor of the present invention is characterized in that the retaining seat 30, the bearing 40 and the retaining ring 50 are disposed into the shaft tube 11 of the base 10 in order, in assembly. And because the outer diameters of the retaining seat 30 and the retaining ring 50 and the diameter of the assembling hole 111 are the same, the retaining seat 30 and the retaining ring 50 never move radially after being mounted into the shaft tube 11, such that radially positioning effect is allowed. Furthermore, by the bearing 40 being sandwiched and positioned between the retaining seat 30 and the retaining ring 50, axial and radial movement of the bearing 40 are prevented assuredly. In the case of the outer diameter of the bearing 40 being equal to the diameter of the assembling hole 111 of the shaft tube 11, the bearing 40 is more securely positioned not to move radially. Besides, the retaining ring 50 abuts against and presses the bearing 40 to position the bearing 40 and the retaining seat 30 to axially provide a reliable positioning effect.

By the arrangement described above, with no radial movement of said components inside the shaft tube 11, central lines of the first axial hole 32, the center hole 41 and the second axial hole 52 certainly align with each other after the retaining seat 30, the bearing 40 and the retaining ring 50 are mounted into the shaft tube 11 of the base 10. And thereby, an unhindered passage for the shaft 61 to go through the second axial hole 52, the center hole 41 and the first axial hole 32 is assured. Further, due to no axial movement of the retaining seat 30, the bearing 40 and the retaining ring 50, each first retaining plate 31 of the retaining seat 30 and each second retaining plate 51 of the retaining ring 50 can be partially and unhinderedly received in the first annular groove 611 and the second annular groove 612 respectively to provide the dual retaining function after the shaft 61 passes through the second axial hole 52, the center hole 41 and the first axial hole 32. Additionally, only the retaining seat 30, the bearing 40 and the retaining ring 50 are inside the shaft tube 11 of the base 10, and a oil end cap that is coupled inside the bottom of a shaft tube, threads for combining the oil end cap and the shaft tube, and an annular abutting flange forming on a top of the shaft tube for abutting against a retaining ring are omitted to provide a simplified structure for assembly. Therefore, the motor of the present invention has many advantages, such as enhancement of convenience of assembling and simplification of structure.

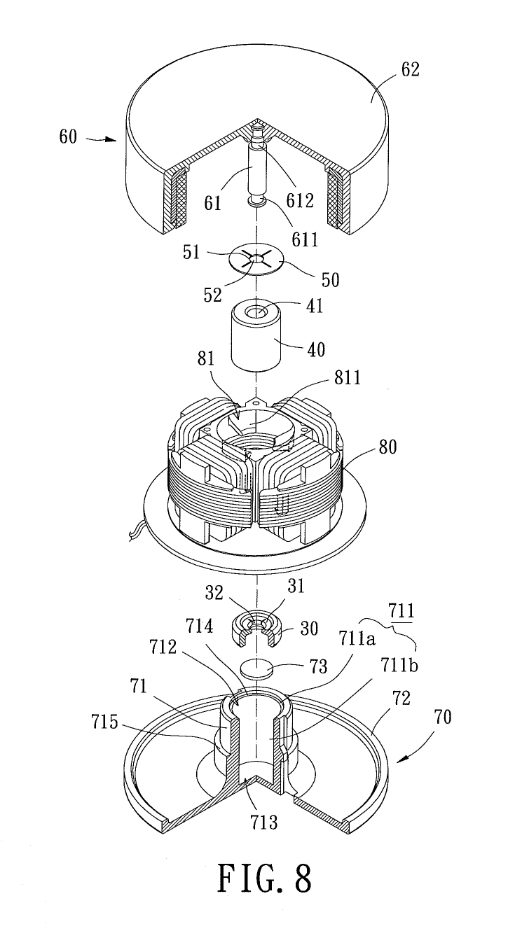

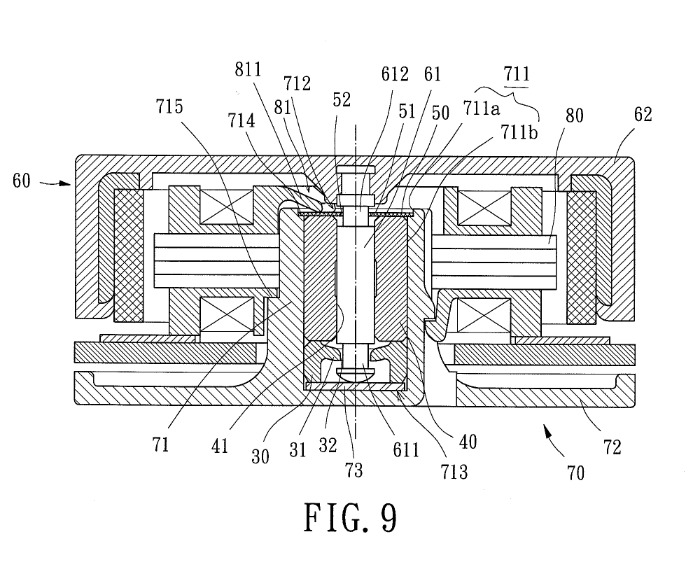

FIGS. 8 and 9, show a motor of a second embodiment according to the preferred teachings of the present invention. The motor includes a base 70, a stator 80, a retaining seat 30, a bearing 40, a retaining ring 50 and a rotor 60, wherein descriptions of the retaining seat 30, the bearing 40, the retaining ring 50 and the rotor 60 are omitted.

The base 70 of the second embodiment according to the preferred teachings of the present invention has a shaft tube 71 made of plastics and a plate 72 for the shaft tube 71 to securely mount, wherein the shaft tube 71 and the plate 72 are integrally formed in one piece. The shaft tube 71 has an assembling hole 711 and two ends of the shaft tube 71 are an open end 712 away from the plate 72 and a closed end 713 respectively. The major difference between the first embodiment and the second embodiment is shown as the following. The assembling hole 711 consists of an upper hole 711a and a lower hole 711b in communication with the upper hole 711a, wherein the upper hole 711a and the lower hole 711b are adjacent to the open end 712 and the closed end 713 respectively. Furthermore, a diameter of the upper hole 711a is larger than that of the lower hole 711b, such that a shoulder 714 in an inner surface of the shaft tube 71 defining the assembling hole 711 and between the upper hole 711a and the lower hole 711b is formed. Besides, the shaft tube 71 includes an annular protrusion 715 on an outer periphery thereof, with the annular protrusion 715 providing a supporting face preferably perpendicular to an axis of the shaft tube 71. A wear-resisting plate 73 is received in the shaft tube 71, with the wear-resisting plate 73 being disposed at the bottom of the shaft tube 71 to abut the free end of the shaft 61 to prevent the closed end 713 from wearing away by the shaft 61 during rotation of the rotor 60. Thus, life of the base 70 is prolonged.

The stator 80 of the second embodiment according to the preferred teachings of the present invention is mounted around the shaft tube 71 of the base 70 and on the annular protrusion 715, with a bottom of the stator 80 abutting on the annular protrusion 715. The supporting face of the annular protrusion 715 is opposite to the stator 80 when the base 70 and the stator 80 are assembled, so that the annular protrusion 715 provides the stator 80 with an axial supporting force along the axis of the shaft tube 71 to facilitate the follow-up assembling process. Moreover, an abutting member 81 couples on a top of the stator 80 and is in the form of a plurality of pressing plates 811 with intervals, with two ends of each pressing plate 811 being fixed to an inner periphery of the stator 80 and extending into the assembling hole 711 of the shaft tube 71 of the base 70 respectively. And thereby, after the retaining seat 30, the bearing 40 and the retaining ring 50 are mounted into the shaft tube 71, the ends of the pressing plates 811 extending into the assembling hole 711 can abut against the top of the retaining ring 50 to avoid the retaining seat 30, the bearing 40 and the retaining ring 50 disengaging from the shaft tube 71 of the base 70.

In the second embodiment, the outer diameter of the retaining seat 30 is equal to a diameter of the lower hole 711b and the outer diameter of the retaining ring 50 is equal to a diameter of the upper hole 711a.

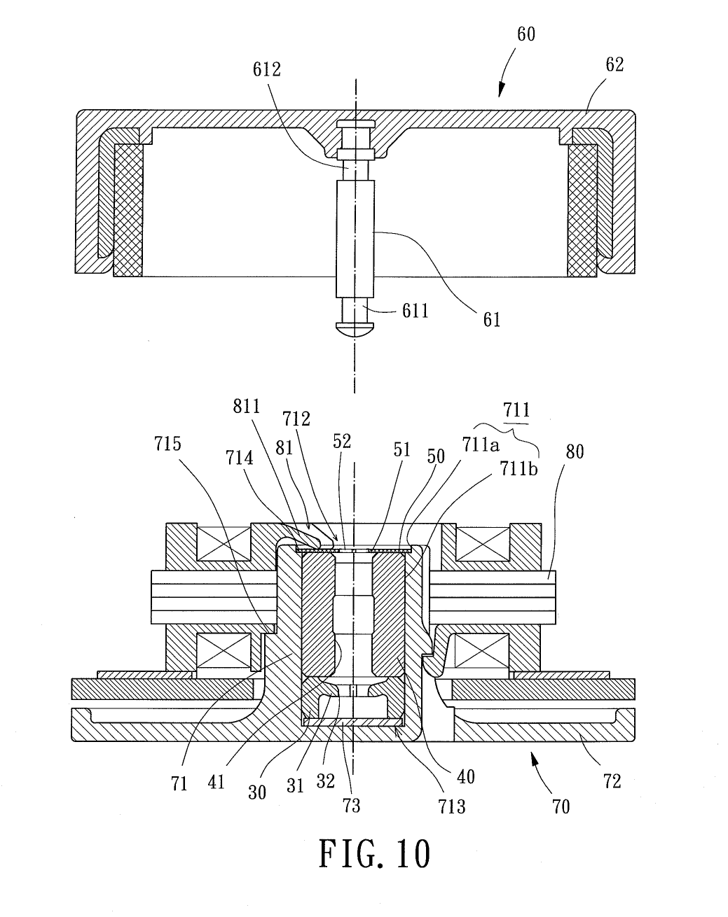

As shown in FIG. 10, in assembly of the motor of the second embodiment according to the preferred teachings of the present invention, the retaining seat 30, the bearing 40 and the retaining ring 50 are mounted into the shaft tube 71 of the base 70. The retaining ring 50 never moves radially after being mounted into the shaft tube 71 due to the outer diameter of the retaining ring 50 the same as the diameter of the upper hole 711a. Further, with the retaining ring 50 abutting against the shoulder 714, it is assured that axial movement of the retaining ring 50 is prevented and a more reliable combination of the retaining ring 50 and the shaft tube 71 is allowed. Therefore, the retaining ring 50 radially abuts on an inner surface defining the upper hole 711a and thus is securely positioned in the shaft tube 71 without axial and radial movement. And because the outer diameter of the retaining seat 30 and the diameter of the lower hole 711b are the same, the retaining seat 30 never moves radially after being mounted into the shaft tube 71, such that radially positioning effect is allowed. Additionally, the bearing 40 is sandwiched and positioned between the retaining seat 30 and the retaining ring 50, so that the bearing 40 moving axially and radially is avoided from.

By the arrangement described above, after the retaining seat 30, the bearing 40 and the retaining ring 50 of the second embodiment are mounted into the shaft tube 71 of the base 70, central lines of the first axial hole 32, the center hole 41 and the second axial hole 52 certainly align with each other to ensure that convenience of mounting the rotor 60 is enhanced. Besides, after the shaft 61 of the rotor 60 passes through the second axial hole 52, the center hole 41 and the first axial hole 32, each first retaining plate 31 of the retaining seat 30 and each second retaining plate 51 of the retaining ring 50 can extend into the first annular groove 611 and the second annular groove 612 respectively. Therefore, convenience of assembling the motor is further improved and structure of the motor is simplified.

Specifically, no matter the first or second embodiment according to the preferred teachings of the present invention, the outer diameter of the retaining seat 30 and the diameter of the assembling hole 111, 711 of the shaft tube 11, 71 are the same size, and the outer diameter of the retaining ring 50 is equal to the diameter of the assembling hole 111, 711 of the shaft tube 11, 71. In this way, with the retaining seat 30 and the retaining ring 50 being arranged in the shaft tube 11, 71, there is no radial movement of the retaining seat 30 and the retaining ring 50. It should be noted that although imperceptible difference between the outer diameters of the retaining seat 30 or the retaining ring 50 and the diameter of the assembling hole 111, 711, which is a tolerance due to manufacturing errors, results in little misalignment of the central lines of the first axial hole 32, the center hole 41 and the second axial hole 52, it will not really affect an assembling procedure of the motor. For example, radial positions of the retaining seat 30 and the retaining ring 50 are not affected in practice, while difference between one of the outer diameters of the retaining seat 30 and the retaining ring 50 and the diameter of the assembling hole 111, 711, is ±0.2 mm.

Moreover, as to the second embodiment according to the preferred teachings of the present invention, the diameter of the second axial hole 52 of the retaining ring 50 is larger than that the first axial hole 32 of the retaining seat 30, so that convenience of assembling is provided and retaining effect as well. Besides, the wear-resisting plate 73, the abutting member 81 and the annular protrusion 715 disclosed in the second embodiment also can be used in the motor of the first embodiment according to the preferred teachings of the present invention.

As has been discussed above, under the condition of the dual retaining function resulting from the double retaining feature, the retaining seat 30, the bearing 40 and the retaining ring 50 can be prevented from moving radially and axially after being mounted into the shaft tube 11, 71. And that leads to no misalignment of the central lines of the first axial hole 32, the center hole 41 and the second axial hole 52, so that each first retaining plate 31 of the retaining seat 30 and each second retaining plate 51 of the retaining ring 50 are able to unhinderedly extend into the first annular groove 611 and the second annular groove 612 respectively, with the rotor 60 coupling to the base 10, 70. Consequently, the simplified structure of the motor of the present invention indeed allows convenience of assembling.

Although the invention has been described in detail with reference to its presently preferable embodiment, it will be understood by one of ordinary skill in the art that various modifications can be made without departing from the spirit and the scope of the invention, as set forth in the appended claims.

What is claimed is:

1. A motor, comprising:
a base having a shaft tube with an assembling hole, with two ends of the shaft tube being an open end and a closed end respectively;
a stator being mounted around the shaft tube;
a retaining seat having a first axial hole and being received in the assembling hole, with the retaining seat being disposed at the closed end of the shaft tube and an outer diameter of the retaining seat being equal to a diameter of the assembling hole;
a bearing having a center hole and being received in the assembling hole of the shaft tube, with the bearing abutting the retaining seat;
a retaining ring having a second axial hole and being received in the assembling hole of the shaft tube, with an outer diameter of the retaining ring being equal to the diameter of the assembling hole, with the bearing being sandwiched and positioned between the retaining ring and the retaining seat; and
a rotor having a shaft with a first annular groove and a second annular groove formed on an outer periphery thereof to respectively form a first neck and a second neck of the shaft, with an outer diameter of the first neck being smaller than a diameter of the first axial hole of the retaining seat and an outer diameter of the second neck being smaller than a diameter of the second axial hole of the retaining ring, with the shaft passing through the second axial hole, the center hole and the first axial hole, with the retaining seat and the retaining ring surrounding and partially extending into the first annular groove and the second annular groove respectively.

2. The motor as defined in claim 1, wherein the assembling hole has an upper hole adjacent to the open end and a lower hole in communication with the upper hole and adjacent to the closed end, with a diameter of the upper hole being larger than a diameter of the lower hole to form a shoulder on an inner surface of the shaft tube defining the assembling hole and between the upper hole and the lower hole, with the outer diameter of the retaining seat being equal to a diameter of the lower hole and the outer diameter of the retaining ring being equal to a diameter of the upper hole, with the retaining ring abutting against the shoulder.

3. The motor as defined in claim 1, wherein an abutting member couples on a top of the stator, with the abutting member abutting against and positioning the retaining ring.

4. The motor as defined in claim 3, wherein the abutting member is in the form of a plurality of pressing plates, with each pressing plate having one end fixed to the stator and another end extending into the assembling hole of the shaft tube of the base, with the ends of the pressing plates which extend into the assembling hole abutting against the retaining ring.

5. The motor as defined in claim 1 further includes a positioning ring coupled in the shaft tube of the base and abutting the retaining ring, with the retaining ring being sandwiched between the positioning ring and the bearing.

6. The motor as defined in claim 5, wherein the positioning ring has an L-shape cross-section from an axial center line of the positioning ring to a radial outer edge thereof.

7. The motor as defined in claim 1, wherein the diameter of the second axial hole of the retaining ring is larger than the diameter of the first axial hole of the retaining seat.

8. The motor as defined in claim 2, wherein the diameter of the second axial hole of the retaining ring is larger than the diameter of the first axial hole of the retaining seat.

9. The motor as defined in claim 3, wherein the diameter of the second axial hole of the retaining ring is larger than the diameter of the first axial hole of the retaining seat.

10. The motor as defined in claim 5, wherein the diameter of the second axial hole of the retaining ring is larger than the diameter of the first axial hole of the retaining seat.

11. The motor as defined in claim 1, wherein the shaft tube includes an annular protrusion on an outer periphery thereof, with a bottom of the stator abutting on the annular protrusion.
